(19) United States
(12) Patent Application Publication
(10) Pub. No.: US 2016/0017084 A1
(43) Pub. Date: Jan. 21, 2016

(54) Mechanically Frothed Gel Elastomers and Methods of Making and Using Them

(71) Applicant: PWE, LLC, Cumberland, RI (US)

(72) Inventors: Richard B. Fox, Northfield, RI (US); Edmund Bard, Cumberland, RI (US)

(21) Appl. No.: 14/730,867

(22) Filed: Jun. 4, 2015

Related U.S. Application Data
(60) Provisional application No. 62/007,655, filed on Jun. 4, 2014.

(51) Int. Cl. C08G 18/08; C08L 75/04

(52) U.S. Cl. CPC C08G 18/14; C08L 75/04

(57) ABSTRACT

A method of making frothed gel in which no blowing (gas producing) agents are used, and in which non-aqueous gel precursor polyol and additive systems are frothed using a froth mix head, either prior to, or after addition of the isocyonate, depending on desired speed of reaction and cell structure. Isocyanate may be added after the material leaves the froth mix head, in which case it can be added to the froth using a static mixer. No water, or very little water, is used in the process.

### FIELD OF THE INVENTION

The present invention relates to new ways to make and use non-aqueous polyurethane gel precursors.

### BACKGROUND OF THE INVENTION

A polyurethane gel is defined by its appearance, typically a clear, bubble-free mass, whose properties can be designed to be hard, soft, rubbery or mushy. Polyurethane gels tend to be tacky to the touch. They are also typically slow to recover upon compression because of the tackiness between cells. Polyurethane gels are typically cool to the touch, at least initially, and can be molded to have a very smooth surface, but they are also very dense and therefore heavy. This structure forms when a polyol and an isocyanate react. The process is designed to carefully avoid any intentional or unintentional water, thereby eliminating the possibility of gas formation. Bubbles of any type (champagne) lead to rejects. Polyurethane foams, on the other hand, which are typically produced by mixing polyol and isocyanate in the presence of water or other blowing agent to chemically produce CO₂, or other gas, can be made to be more lightweight, have somewhat better compression recovery, and exhibit less surface tackiness. However, foams are typically much less smooth to the touch than gels, and foams do not exhibit the cool-to-the-touch properties of gels.

### SUMMARY OF THE INVENTION

According to one embodiment of the invention there is presented a method of making frothed gel in which no blowing (gas producing) agents are used, and in which non-aqueous gel precursor polyol and additive systems are frothed using a froth mix head, either prior to, or after addition of the isocyanate, depending on desired speed of reaction and cell structure.

The present invention relies on the addition of air, nitrogen or other inert gas pumped under pressure into a mixing head that incorporates the gas by high shear mechanical agitation. Accordingly, the need for the reaction between water and isocyanate to chemically produce a gas in the mixing head can be reduced or eliminated, depending on what properties are needed in the final product. In fact, water can be scrupulously avoided to avoid gas production and formation of urea units. Alternatively, water can be intentionally added in low quantities (e.g., less than 5%, less than 2%, less than 1%, or less than 0.5%, by weight or volume) to chemically produce gas and urea units.

According to an embodiment of the invention, there is provided is a non-aqueous gel elastomer that has been mechanically frothed (without chemical blowing), dispensed and then allowed to cure. Once cured, the material retains its shape under compression and rebounds to original shape at a variable rate depending on chemistry and process. The material has a wonderful hand that gives a very different feel as compared to memory foams. Specifically, the material is surprisingly and exceedingly soft and extremely pliable, notwithstanding its shape memory characteristics.

The frothed gel of the invention is particularly suitable for use in body-contacting applications where extreme softness combined with good recovery is paramount. The frothed gel of the invention is particularly suited for the manufacture of ear buds, ear muffs/ear phones, bras and bra inserts, and breast pads.

Due to its unexpectedly superior softness and resiliency, the frothed gel of the invention can be used as a comfort and performance gasket between mask and face, for all types of face mask applications, including pilot masks, diving mask, swim goggles, sleep apnea masks, oxygen masks, and the like.

In addition, the frothed gel of the invention can be used to manufacture shaped and sheet stock used in furniture applications such as mattress toppers, arm cushions, wheel chair cushions etc.

### DETAILED DESCRIPTION OF THE INVENTION

Gel precursor polyurethanes are produced by mixing two or more liquid streams. The isocyanate is usually added by itself and the polyol stream is usually more complex, containing catalysts, surfactants, blowing agents and so on. The two components are referred to as a polyurethane system, or simply a system. The isocyanate is commonly referred to in North America as the ‘A-side’ or just the ‘iso’. The blend of polyols and other additives is commonly referred to as the ‘B-side’ or as the ‘poly’. This mixture might also be called a ‘resin’ or ‘resin blend’. In Europe the meanings for ‘A-side’ and ‘B-side’ are reversed. Resin blend additives may include surfactants, pigments, and fillers. Polyurethane can be made in a variety of densities and hardnesses by varying the isocyanate, polyol or additives.

### Isocyanates

Isocyanates used to make polyurethane must have two or more isocyanate groups on each molecule. The most commonly used isocyanates are the aromatic diisocyantes, toluene diisocyanate (TDI) and methylene diphenyl diisocyanate, MDI.

TDI and MDI are generally less expensive and more reactive than other isocyanates. Industrial grade TDI and MDI are mixtures of isomers and MDI often contains polymeric materials. They are used to make flexible foam (for example slabstock foam for mattresses or molded foams for car seats), rigid foam (for example insulating foam in refrigerators) elastomers (shoe soles, for example), and so on. The isocyanates may be modified by partially reacting them with polyols or introducing some other materials to reduce volatility (and hence toxicity) of the isocyanates, decrease their freezing points to make handling easier or to improve the properties of the final polymers.

Aliphatic and cycloaliphatic isocyanates are used in smaller volumes, most often in coatings and other applications where color and transparency are important since polyurethanes made with aromatic isocyanates tend to darken on exposure to light.[14] The most important aliphatic and cycloaliphatic isocyanates are 1,6-hexamethylene diisocyanate (HDI), 1-isocyanato-3-isocyanatomethyl-3,5,5-trimethyl-cyclohexane (isophorone diisocyanate, IPDI), and 4,4′-diisocyanato dicyclohexylmethane, (H12MDI or hydrogenated MDI).

### Polyols

Polyols can be polyether polyols, which are made by the reaction of epoxides with an active hydrogen-containing starter compound, or polyester polyols, which are made by the polycondensation of multifunctional carboxylic acids and hydroxyl compounds. They can be further classified according to their end use. Higher molecular weight polyols (molecular weights from 2,000 to 10,000) are used to make more flexible polyurethanes while lower molecular weight polyols make more rigid products.

Polyols for flexible applications use low functionality initiators such as dipropylene glycol (f=2), glycerine (f=3) or a sorbitol/water solution (f=2.75).[15] Polyols for rigid applications use high functionality initiators such as sucrose (f=8), sorbitol (f=6), toluenediamine (f=4), and Mannich bases (f=4). Propylene oxide and/or ethylene oxide is added to the initiators until the desired molecular weight is achieved. The order of addition and the amounts of each oxide affect many polyol properties, such as compatibility, water-solubility, and reactivity. Polyols made with only propylene oxide are terminated with secondary hydroxyl groups and are less reactive than polyols capped with ethylene oxide, which contain a higher percentage of primary hydroxyl groups. Graft polyols (also called filled polyols or polymer polyols) contain finely dispersed styrene-acrylonitrile, acrylonitrile, or polyurea (PHD) polymer solids chemically grafted to a high molecular weight polyether backbone. They are used to increase the load-bearing properties of low-density high-resiliency (HR) foam, as well as add toughness to microcellular foams and cast elastomers. Initiators such as ethylenediamine and triethanolamine are used to make low molecular weight rigid foam polyols that have built-in catalytic activity due to the presence of nitrogen atoms in the backbone. A special class of polyether polyols, poly(tetramethylene ether) glycols, which are made by polymerizing tetrahydrofuran, are used in high performance coating, wetting and elastomer applications.

For this invention, the following hydroxyl containing compounds may be used:

Any hydroxyl containing pure compound and/or mixtures thereof that offer primary reactivity of attached hydroxyl functionality with isocyanate groups and contain functionality as hydroxyl from 1 to 10 and molecular weight from 30 to 10,000. (Includes but not limited to hydroxyl containing compounds with backbone structures of Polyester, PPG Polyether, EO endcapped PPG Polyether, PEG Polyether, PTMEG Polyether, Hydroxyl containing natural Oils (Castor, etc), Synthetic Oils, Polycaprolactones, Hydroxyl Functional Acrylates, Renewable Source hydroxyl compounds based upon natural ingredients (Soybean, Castor, Sucrose, Sorbitol, etc), Hydroxyl Functional Alkyd resins, alcohols (including glycol ethers), glycols, 2+ hydroxyl functional hydrocarbons, and mixtures thereof). These are all chemically possible to be used in your process. This does eliminate amino alcohols (primary or secondary amino functionality only—not tertiary amino alcohols), polyamides, and primary and secondary amino compounds ie. Jeffamines).

Preferred: Any hydroxyl containing compound and/or mixtures thereof that offers primary reactivity of attached hydroxyl functionality with isocyanate groups and contains functionality as hydroxyl from 1 to 10 and molecular weight from 30 to 10,000 and offer high elongation and low modulus (Both need to be quantified) when reacted with isocyanate as are common and known in the art. (This eliminates highly crystalline polyesters, hard amorphous polyester type polyols, many alkyds and many acrylates)

Preferred: Any hydroxyl containing compound and/or mixtures thereof that offers primary reactivity of attached hydroxyl functionality with isocyanate groups and contains functionality as hydroxyl from 1 to 8 and molecular weight from 1000 to 8,000 and offer high elongation and low modulus (Both need to be quantified) when reacted with isocyanate as are common and known in the art and are liquid (viscosity needs to be quantified as per your process) at process temperatures (process temperatures need to be quantified). (This potentially eliminates many more polyesters, alkyds and acrylates and can eliminate PTMEG Ethers if your stated process temperature is too low-PTMEG is a solid at room temperature)

### Catalysts

Polyurethane catalysts can be classified into two broad categories, amine compounds and metal complexes. Traditional amine catalysts have been tertiary amines such as triethylenediamine (TEDA, 1,4-diazabicyclo[2.2.2]octane or DABCO), dimethylcyclohexylamine (DMCHA), and dimethylethanolamine (DMEA). Tertiary amine catalysts are selected based on whether they drive the urethane (polyol+isocyanate, or gel) reaction, the urea (water+isocyanate, or blow) reaction, or the isocyanate trimerization reaction (e.g., using potassium acetate, to form isocyanurate ring structure). Catalysts that contain a hydroxyl group or secondary amine, which react into the polymer matrix, can replace traditional catalysts thereby reducing the amount of amine that can come out of the polymer.

Metallic compounds based on mercury, lead, tin, bismuth, and zinc are used as polyurethane catalysts. Mercury carboxylates, are particularly effective catalysts for polyurethane elastomer, coating and sealant applications, since they are very highly selective towards the polyol+isocyanate reaction, but they are toxic. Bismuth and zinc carboxylates have been used as alternatives. Alkyl tin carboxylates, oxides and mercaptides oxides are used in all types of polyurethane applications. Tin mercaptides are used in formulations that contain water, as tin carboxylates are susceptible to hydrolysis.

The catalyst is critical by contributing to froth stability and integrity as it promotes the polyol/isocyanate reaction that builds polymer molecular weight and ultimately strength. This stability is needed for the froth to survive the trip through the delivery tube and any post handling in the molding operation before full cure. The catalyst SND is dibutyltin dilaurate, but other organometallic compounds also work well, such as zinc, nickel, iron, bismuth, etc. For the current process, which injects isocyanate after the mixing head, more active catalysts, such as organotin compounds, can be used.

### Surfactants

Surfactants are used to modify the characteristics of both foam and non-foam polyurethane polymers. They take the form of polydimethylsiloxane-polyoxyalkylene block copolymers, silicone oils, nonylphenol ethoxylates, and other organic compounds. In foams, they are used to emulsify the liquid components, regulate cell size, and stabilize the cell structure to prevent collapse and sub-surface voids. In non-foam applications they are used as air release and anti-foaming agents, as wetting agents, and are used to eliminate surface defects such as pin holes, orange peel, and sink marks.

The surfactant stabilizes the froth during the intense mixing and promotes the incorporation of gas into the polyol mixture, which would normally lack integrity, resulting in defoaming, if un-aided by a surfactant. For the gel product of the invention that is not designed to entrain air and that is carefully handled to avoid bubbles, the production of a stable foam is unique. The surfactant may be an (AB)n type, where “A” is a linear difunctional siloxane chain and “B” is an alkyleneoxide diol chain. Various mole weights of surfactant and diol may be used. These groups are condensed (i.e., strung together) to form repeating linear units of A-B-A-B-A-B etc. “n” times until the desired molecular weight and viscosity are reached. The high molecular weight is attained by condensing “M” units, consisting of monofunctional silicones and monofunctional polyalkyleneoxides, with “Q” units, consisting of tetrafunctional silicones.

According to one embodiment of the invention there is presented a method of making frothed gel in which no blowing (gas producing) agents are used, and in which non-aqueous gel precursor polyol and additive systems are frothed using a froth mix head, either prior to, or after addition of the isocyonate, depending on desired speed of reaction and cell structure. According to a preferred embodiment, isocyanate is added after the material leaves the froth mix head. According to the embodiment in which the isocyanate is added after the material leaves the froth mix head, the isocyanate can be added to the froth using a static mixer. Catalyst can likewise be modified to affect the speed of the reaction, the safeness of the material to unprotected skin, and the cell structure. Fillers can be added to modify the tact, hardness and rebound time of the material. Catalysts and/or fillers may be added prior to frothing, or after frothing, before, during, or after addition of the isocyanate.

Following post-frothing mixing (if necessary), the frothed gel may be formed/cured into desired shapes using known molding techniques. The frothed gel may be molded into 2-dimensional, 2.5-dimensional, and 3-dimensional articles. Films and/or fabrics may be added to the material during the mold process to make a finished part where all layers are bonded together, for example: film—froth gel—fabric. The frothed gel material may also be introduced to open molds with mold releases or into coated molds, and pull molded products off the molds without film or fabric.

### Recipe:

| | Example | Broad | |
|---|---|---|---|
| Material | Chemical | Range | Lever Effect |
| Polyol | LU 1018 | 50-60% | The base polymer, % varies based upon |
| | | | below percentages. |
| Catalyst | SND | 0-5% | Increasing catalyst speeds up the |
| | | | reaction and modifies the cell |
| | | | structure which can result in a |
| | | | harder durometer and a faster |
| | | | rebound time. |
| Mono | LG 9005 | 0-15% | Increasing this additive results in a |
| Functional | | | softer feeling material and generally |
| Additive | | | reduces durometer and increases |
| | | | rebound time. |
| Filler | CC103 | 0-20% | Inert filler displaces higher cost |
| | | | materials and by increasing filler |
| | | | percentage can increase the viscosity |
| | | | of the Polyol mix, increase material |
| | | | density and decrease rebound time. |
| Pigment | Black | 0-5% | Changes the color of the finished |
| | 99430 | | material. |
| Surfactant | EPH-84 | 0-20% | Is a lever used in processing to modify |
| | | | the cell structure for better |
| | | | processability. |
| Isocyanate | LU 5006 | 15-20% | In ratio with the polyol and % varies |
| | | | with other additives. |

Some of the product measured ranges are:

| Physical Properties | UOM | Range |
|---|---|---|
| Density | LB/CuFt | 10-30 |
| Durometer | Shore 00 | <70 |
| Color | Pantone | Any solid color |
| Rebound time | Seconds | 1-600 |

### Process:

Generally, the Polyol, catalyst, mono functional additive, filler and pigment are premixed and called mixed Polyol. The mixed Polyol is then metered into a frothing head with the surfactant and an inert gas. The Isocyanate may be added in the head, if not it is metered with the contents of the froth head through post mixers prior to dispensing into molds.

### Process Parameters:

| Process Parameters | UOM | Range |
|---|---|---|
| Process Temperatures | F. | 70-90 |
| Process Pressures | Psi | 10-40 psi |
| Chemical Throughput | grams/sec | 20-60 |
| Mixer Speed | RPM | 400-600 |

### Froth Gel Characteristics:

The frothed gel according to the invention is a gel elastomer that has been mechanically frothed (without blowing), dispensed and then allowed to cure. Once cured, the material retains its shape under compression and rebounds to original shape at a variable rate depending on chemistry and process. The material has a wonderful hand that gives a very different feel as compared to memory foams. Specifically, the material is surprisingly and exceedingly soft and extremely pliable, notwithstanding its shape memory characteristics.

The material can be pigmented to any color. The product can be thermoformed at various temperatures. The frothed gel chemistry and or process can be modified to change the density, durometer and/or recovery rate.

Products Made from Frothed Gel

The frothed gel of the invention is particularly suitable for use in body-contacting applications where extreme softness combined with good recovery is paramount. The frothed gel of the invention is particularly suited for the manufacture of the following products:

Ear Bud Inserts—The frothed gel of the invention can be used to make ear bud inserts. According to this embodiment of the invention, the frothed gel inserts preferably have a film over the outside (the area that touches the user's hands and ear canal). This allows the product to stay cleaner, have a different feel and possibly perform testing better. The film may or may not be permeable and can have various colors, textures and or prints. Initial tests show that ear bud inserts made with the frothed gel of the present invention, results in a product with surprisingly superior softness and feel.

Frothed Gel Ear Muffs/Ear Phones—The frothed gel of the invention can be used to make ear muffs and ear phones. The outside of the ears are very sensitive to pressure, and can become uncomfortable and painful after extended use of even with the softest available prior art ear muffs and ear phones. According to this embodiment of the invention, the frothed gel of the invention may be used to produce headsets of superior quality and softness, for noise cancellation, safety noise reduction and sealing ears for audio usage and communication.

Frothed Gel Bra inserts—The frothed gel of the invention can be used to make bra inserts, both as part of the manufactured bra and as after-market products.

Frothed Gel Breast pads—The frothed gel of the invention can be used to make after-market breast pads that go between the breast and the bra.

Frothed Gel component in the bra cup—The frothed gel of the invention can be used to make to bra cups or a part of the bra cup, to change the feel and support of the bra.

Gel infused bras—Infusing gel (cooling and non) into foam and then into bras with and without films. This is to change the feel of the bra, aid in support of the breast and or cool the breast.

Due to its unexpectedly superior softness and resiliency, the frothed gel of the invention can be used as a comfort and performance gasket between mask and face, for all types of face mask applications, including pilot masks, diving mask, swim goggles, sleep apnea masks, oxygen masks, and the like.

Frothed gel for glasses—again, due to its unexpectedly superior softness and resiliency, the frothed gel of the invention can be used for padding in eyeglasses—as sides against head and against the nose, for both comfort and fit.

Shaped frothed gel comfort pads—The frothed gel of the invention can be used to make comfort pads—as inserts, as custom affixed parts and/or as peel and stick comfort pads for use in areas like helmets—sports, bike, medical etc.

In addition, the frothed gel of the invention can be used to manufacture shaped and sheet stock used in furniture applications such as mattress toppers, arm cushions, wheel chair cushions etc.

The frothed gel of the invention can be molded using the techniques and adjunct materials (e.g., films, supports, etc.) set forth in U.S. Pat. No. 7,827,704; U.S. patent application Ser. No. 11/644,266, U.S. patent application Ser. No. 12/423,174; and U.S. patent application Ser. No. 13/008,471, the disclosures of which are hereby incorporated herein in their entirety.

1. A method of making a non-aqueous frothed gel in which no blowing (gas producing) agents are used, and in which non-aqueous gel precursor polyol and additive systems are frothed using a froth mix head, either prior to, or after addition of the isocyanate, the method comprising preparing a mixed Polyol by pre-mixing Polyol, catalyst, mono functional additive, filler and (optionally) pigment, and metering said mixed polyol into the froth mix head.

2. A method according to claim 1, which uses no water.

3. A method according to claim 1, which uses less than 2% by volume of water.

4. A method according to claim 1, wherein polyol is used in the amount of 50%-60%, catalyst is used in the amount of 0%-5%, monofunctional additive is used in the amount of 0%-15%, filler is used in the amount of 0%-20%, pigment is used in the amount of 0%-5%, surfactant is used in the amount of 0%-20%, and isocyanate is used in the amount of 15%-20%.

5. A method according to claim 1, wherein the process is carried out at 70°-90° F., 10-40 psi, with a chemical throughput of 20-60 grams/sec, and with a mixer speed of 400-600 RPM.

6. A mechanically frothed gel comprising polyol in the amount of 50%-60%, in the amount of 0%-5%, monofunctional additive in the amount of 0%-15%, filler in the amount of 0%-20%, pigment in the amount of 0%-5%, surfactant in the amount of 0%-20%, and isocyanate in the amount of 15%-20%.

7. A mechanically frothed gel according to claim 6, comprising less than 2% water.

8. A mechanically frothed gel according to claim 6, comprising less than 1% water.

9. A mechanically frothed gel according to claim 6, having a density of 10-30 Lb/CuFt, a durometer of greater than 70 Shore)), and a rebound time of from 1-600 seconds.
